(19) United States
(12) Patent Application Publication
(10) Pub. No.: US 2023/0333280 A1
(43) Pub. Date: Oct. 19, 2023

(54) SCALING AND STATISTICAL ADJUSTMENTS OF PRECIPITATION RATES FOR APPARATUSES HAVING PRECIPITATION SENSITIVE SENSORS

(71) Applicant: GOOGLE LLC, Mountain View, CA (US)

(72) Inventor: William B. Gail, Boulder, CO (US)

(21) Appl. No.: 18/044,745

(22) PCT Filed: Sep. 22, 2020
(86) PCT No.: PCT/US2020/051911

§ 371 Date: Mar. 9, 2023

(51) Int. Cl. G01W 1/10; G01W 1/14

(52) U.S. Cl. CPC G01W 1/10; G01W 1/14; G01W 2203/00

(57) ABSTRACT

A system (100) for scaling and statistical adjustments of precipitation rates for apparatuses having precipitation sensitive sensors. The system (100) includes a weather information station (120) configured to provide precipitation rates for areas of a region and a processor (130) in communication with the weather information station (120). The processor (130) is configured to obtain the precipitation rates of the areas of the region, determine a climatological metrics relationship between at least two climatological metrics of the precipitation rates, determine an operational metrics relationship between at least two operational metrics of the precipitation rate, compare the climatological metrics relationship with the operational metrics relationship. The processor (130) is also configured to determine at least one of a probability associated with a predetermined exceedance rate threshold and an exceedance rate threshold associated with a predetermined probability.

### TECHNICAL FIELD

The embodiments described below relate to weather information and, more particularly, to scaling and statistical adjustments of precipitation rates for apparatuses having precipitation sensitive sensors.

### BACKGROUND

There are many different methods for measuring and/or predicting amount or rate of precipitation. Each use case determines which measurement or prediction method is most relevant. Often, a particular method involves integrating in either space or time. Weather radar, for example, typically provides second-scale samples taken every few minutes at a given spatial location, integrated over an area such a one square km. In contrast, rain gauges measure over areas smaller than one square meter but typically integrate over 5-60 minutes before presenting a measurement. These scales and measurement times may be suitable for some use cases, such as traditional weather reporting for consumers.

However, some use cases are best served by a reliable estimate of a localized (e.g., within 100 m), instantaneous (e.g., within about 10 to 60 seconds) precipitation rate. A localized instantaneous precipitation rate, from the perspective of a person, is equivalent to “how hard is it raining on me right now”. Historically, climatological estimates of instantaneous precipitation rates were prepared by the telecommunications industry for use in planning outage percentages on microwave links. The climatological estimates of the precipitation rates are typically available through organizations such as the International Telecommunications Union (ITU) and in the academic literature. The telecommunication standard is the localized precipitation rate averaged over one minute.

However, what is not available is a means for estimating fine-scale precipitation rates and their variations in real-time in a comprehensive manner for large numbers of locations across large regions. Very few instruments are available to measure such precipitation rates, and weather models work at considerably reduced spatial (multiple km) and temporal (generally hourly) scales. In addition, such instruments may suffer from reliability issues and lack sufficient spatial coverage to be suitable for purposes such as automated driving. Accordingly, there is a need for scaling and statistical adjustments of precipitation rates, derived from widely available observations, for purposes such as automated driving.

### SUMMARY

A system for scaling and statistical adjustments of precipitation rates for apparatuses having precipitation sensitive sensors. According to an embodiment, the system comprises a weather information station configured to provide precipitation rates for areas of a region and a processor in communication with the weather information station. The processor is configured to obtain the precipitation rates of the areas of the region, determine a climatological metrics relationship between at least two climatological metrics of the precipitation rates, determine an operational metrics relationship between at least two operational metrics of the precipitation rate, and compare the climatological metrics relationship with the operational metrics relationship. The processor is also configured to determine at least one of a probability associated with a predetermined exceedance rate threshold and an exceedance rate threshold associated with a predetermined probability.

A method for scaling and statistical adjustments of precipitation rates for apparatuses having precipitation sensitive sensors is provided. According to an embodiment, the method comprises obtaining precipitation rates for areas of a region, determining a climatological metrics relationship between at least two climatological metrics of the precipitation rates, determining an operational metrics relationship between at least two operational metrics of the precipitation rates, and comparing the climatological metrics relationship with the operational metrics relationship. The method further comprises determining at least one of a probability associated with a predetermined exceedance rate threshold, and an exceedance rate threshold associated with a predetermined probability.

### ASPECTS

According to an aspect, a system (100) for scaling and statistical adjustments of precipitation rates for apparatuses having precipitation sensitive sensors comprises a weather information station (120) configured to provide precipitation rates for areas of a region and a processor (130) in communication with the weather information station (120). The processor (130) is configured to obtain the precipitation rates of the areas of the region, determine a climatological metrics relationship between at least two climatological metrics of the precipitation rates, determine an operational metrics relationship between at least two operational metrics of the precipitation rate, and compare the climatological metrics relationship with the operational metrics relationship. The processor (130) is also configured to determine at least one of a probability associated with a predetermined exceedance rate threshold, and an exceedance rate threshold associated with a predetermined probability.

Preferably, the at least two climatological metrics comprises a maximum and a mean of a climatological sample of the precipitation rates of the areas of the region, and the at least two operational metrics comprises a maximum and a mean of an operational sample of the precipitation rates of the areas of the region.

Preferably, the climatological metrics relationship comprises a relationship between the maximum and the mean of the climatological sample of the precipitation rates of the areas of the region, and the operational metrics relationship comprises a relationship between the maximum and the mean of the operational sample of the precipitation rates of the areas of the region.

Preferably, the probability associated with the predetermined exceedance rate threshold and the predetermined probability are a probability that a maximum precipitation rate of one or more areas of the region is greater than the predetermined exceedance rate threshold.

Preferably, the processor (130) is further configured to perform a spatial-scale adjustment of the precipitation rates of the areas of the region to a spatial-scale of an operational region.

Preferably, the processor (130) is further configured to perform a temporal-scale adjustment of the precipitation rates of the areas of the region to a temporal-scale of an operational period.

Preferably, the exceedance rate threshold is based on a maximum precipitation rate of a sensor in a vehicle.

According to an aspect, a method for scaling and statistical adjustments of precipitation rates for apparatuses having precipitation sensitive sensors, the method comprising obtaining precipitation rates for areas of a region, determining a climatological metrics relationship between at least two climatological metrics of the precipitation rates, determining an operational metrics relationship between at least two operational metrics of the precipitation rates, and comparing the climatological metrics relationship with the operational metrics relationship. The method also comprises determining at least one of a probability associated with a predetermined exceedance rate threshold and an exceedance rate threshold associated with a predetermined probability.

Preferably, the at least two climatological metrics comprise a maximum and a mean of a climatological sample of the precipitation rates of the areas of the region and the at least two operational metrics comprise a maximum and a mean of an operational sample of the precipitation rates of the areas of the region.

Preferably, the climatological metrics relationship comprises a relationship between the maximum and the mean of the climatological sample of the precipitation rates of the areas of the region and the operational metrics relationship comprises a relationship between the maximum and the mean of the operational sample of the precipitation rates of the areas of the region.

Preferably, the probability associated with a predetermined exceedance rate and the predetermined probability is a probability that a maximum precipitation rate of one or more areas of the region is greater than the predetermined exceedance rate threshold.

Preferably, the method further comprises performing a spatial-scale adjustment of the precipitation rates of the areas of the region to a spatial-scale of an operational region.

Preferably, the method further comprises performing a temporal-scale adjustment of the precipitation rates of the areas of the region to a temporal-scale of an operational period.

Preferably, the exceedance rate threshold is based on a maximum precipitation rate of a sensor in a vehicle.

### BRIEF DESCRIPTION OF THE DRAWINGS

The same reference number represents the same element on all drawings. It should be understood that the drawings are not necessarily to scale.

FIG. 1 shows a system 100 for scaling and statistical adjustments of precipitation rates for a vehicle having precipitation sensitive sensors.

FIG. 2 shows a vehicle electronics 200 configured to manage a control system based in part on the determination of a probability that a maximum precipitation rate of a sensor is exceeded.

FIG. 3 shows a diagram 300 illustrating how metrics may be calculated.

FIG. 4 shows a flow chart 400 for determining a probability that a maximum precipitation rate of a sensor is exceeded.

FIG. 5 shows a chart 500 illustrating a spatial-scale adjustment of an observed precipitation rate value.

FIG. 6 shows a chart 600 illustrating a temporal-scale adjustment from a relatively long measurement integration time to a sensor measurement integration time of 10 seconds.

FIG. 7 shows a chart 700 illustrating probability distributions of a climatological metrics relationship between a maximum precipitation rate and a mean precipitation rate.

FIG. 8 shows a method 800 for scaling and statistical adjustments of precipitation rates for automated driving.

### DETAILED DESCRIPTION

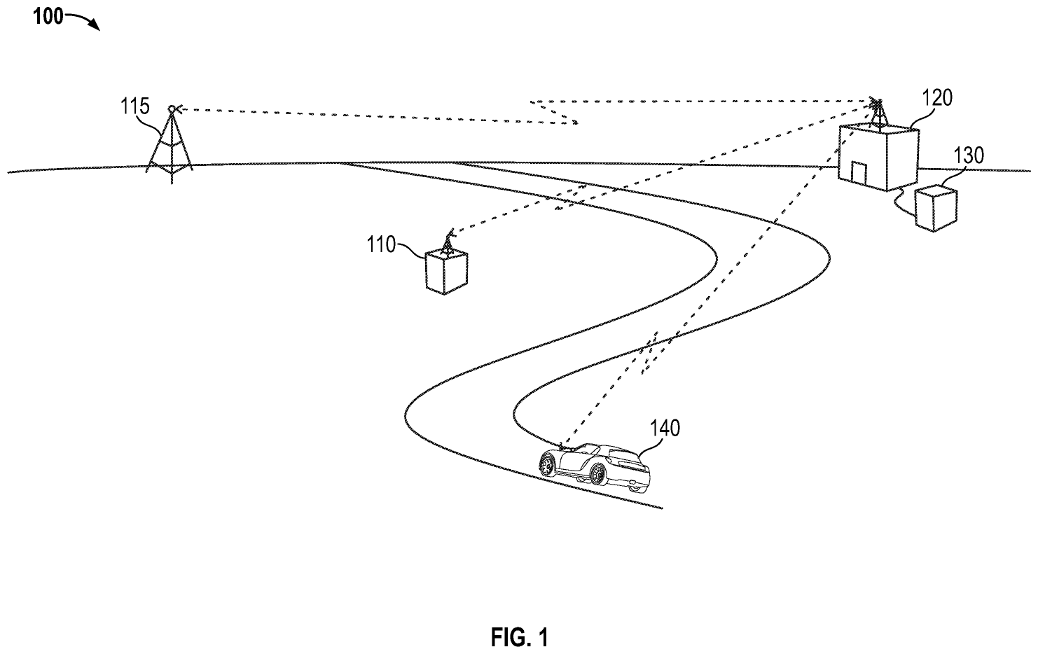

FIGS. 1-8 and the following description depict specific examples to teach those skilled in the art how to make and use the best mode of embodiments of scaling and statistical adjustments of precipitation rates for apparatuses having precipitation sensitive sensors. For the purpose of teaching inventive principles, some conventional aspects have been simplified or omitted. Those skilled in the art will appreciate variations from these examples that fall within the scope of the present description. Those skilled in the art will appreciate that the features described below can be combined in various ways to form multiple variations of the scaling and statistical adjustments of precipitation rates for apparatuses having precipitation sensitive sensors. As a result, the embodiments described below are not limited to the specific examples described below, but only by the claims and their equivalents.

FIG. 1 shows a system 100 for scaling and statistical adjustments of precipitation rates for a vehicle having precipitation sensitive sensors. As shown in FIG. 1, the system includes a weather station 110, an input weather prediction model 115, and a weather information station 120. As shown in FIG. 1, the weather station 110 and the weather information station 120 are communicatively coupled with each other. The weather information station 120 may be configured to receive stationary observation data provided by the weather station 110. Additionally, or alternatively, the weather information station 120 may be configured to receive stationary observation data provided by one or more other weather stations and model data from one or more other input weather prediction models.

As shown in FIG. 1, the system 100 also includes a processor 130 that is communicatively coupled with the weather information station 120. As shown in FIG. 1, the processor 130 is separate from the weather information station 120, although the processor 130 may be part of the weather information station 120. Although the system 100 is shown as including the weather station 110, the system 100 may be comprised of the weather information station 120 and the processor 130. The processor 130 may be configured to perform post-processing on one or more weather prediction models. With more specificity, the processor 130 may be configured to determine a probability that a precipitation rate threshold of a sensor is exceeded, as will be described in more detail in the following.

The system 100 may also include a vehicle 140 that is communicatively coupled with the processor 130. Although not shown, the vehicle 140 may be alternatively or additionally communicatively coupled to the weather information station 120 so as to receive or send data. For example, where the processor 130 is part of the weather information station 120, the vehicle 140 may be communicatively coupled with the weather information station 120. The data provided by the vehicle 140 may be mobile observation data. The vehicle 140 may also represent any device capable of providing mobile observation data.

The weather station 110 may be configured to determine weather conditions at or proximate to the weather station 110. For example, the weather station 110 may include weather sensors such as, for example, barometers, rain gauge sensors, radio detection and ranging (RADAR), wind meters, humidity sensors, etc. Accordingly, the weather station 110 may be configured to provide stationary observation data. The stationary observation data may include a plurality of stationary observation values that can be used by the weather information station.

The input weather prediction model 115 is shown as being communicatively coupled to the weather information station 120. The input weather model 115 may include a weather prediction model of an area that includes the system 100, such as a portion of the system. A plurality of the input weather prediction models 115 may provide data to the weather information station 120.

The weather information station 120 may receive, aggregate, analyze, process, or the like, weather information from the weather station 110 and/or processor 130. For example, the weather information station 120 may receive weather related information from the weather station 110 such as precipitation rates for areas in a region. The precipitation rates may, for example, have associated spatial and temporal scales. For example, the precipitation rates provided by the weather station 110 may be for relatively small areas (e.g., a square meter) with relatively large integration or accumulation times (e.g., 1 hour), such as those commonly obtained by using rain gauges and/or relatively large areas (e.g., 16 square-kilometer) with relatively short integration times (e.g., 5 seconds), such as commonly obtained by using weather radars.

The weather information station 120 may also provide weather related information to the weather station 110 and/or processor 130. For example, the weather information station 120 may provide information to the weather station 110 about inclement weather so that the weather station 110 may make adjustments that are more suited to the inclement weather. The weather information station 120 may or may not include the processor 130.

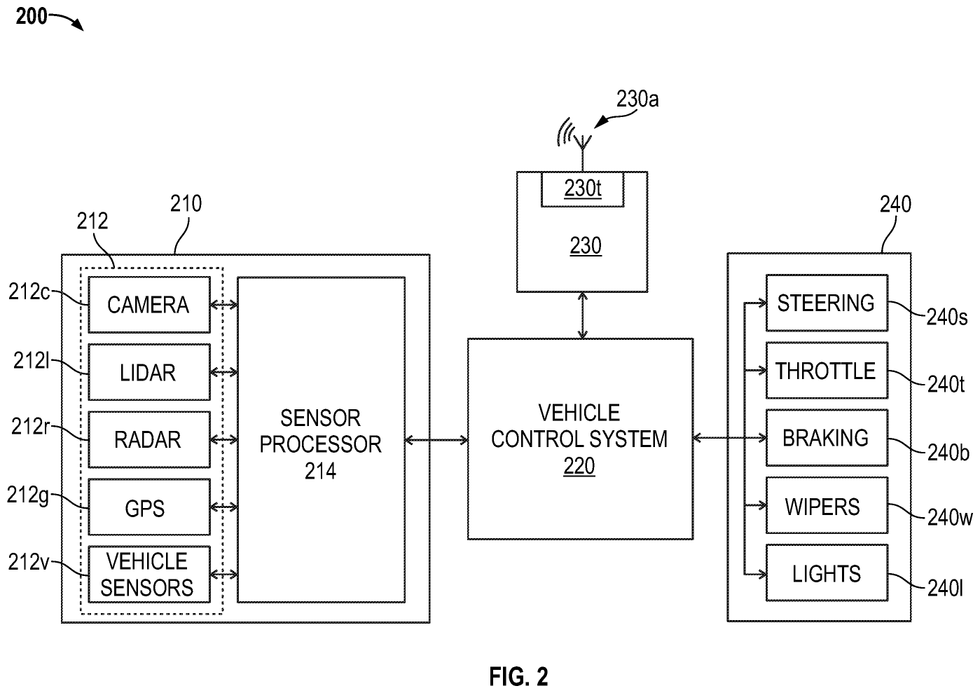

The processor 130 may be configured to exchange data with the vehicle 140. For example, the processor 130 may be configured to receive data related to sensors in the vehicle 140. As will be described in more detail in the following with reference to FIG. 2, the vehicle 140 may provide to the processor 130 via the weather information station 120, a maximum precipitation rate for one or more sensors in the vehicle. The maximum precipitation rate may be a precipitation rate at which the sensor degrades such that a processor in the vehicle 140 needs to make adjustments, such as relying more on other sensors, adjusting a speed and/or direction of the vehicle 140, turning at least a portion of control of the vehicle 140 over an operator of the vehicle, etc.

FIG. 2 shows a vehicle electronics 200 configured to manage a control system based in part on the determination of a probability that a maximum precipitation rate is exceeded. As shown in FIG. 2, the vehicle electronics 200 includes a sensor system 210 that is communicatively coupled with a vehicle control system 220. The vehicle control system 220 is communicatively coupled to a vehicle processing system 230. The vehicle processing system 230 is shown as including a vehicle processing system transceiver 230t that is communicatively coupled to an antenna 230a. The vehicle control system 220 is also communicatively coupled to a plurality of vehicle control devices 240.

The sensor system 210 is shown in FIG. 2 as being comprised of a plurality of sensors 212 that are communicatively coupled to a sensor processor 214. As shown, in FIG. 2, the plurality of sensors 212 is comprised of a camera 212c, a light detection and ranging sensor (“LIDAR”) 2121, a radar detection and ranging sensor (“RADAR”) 212r, a global positioning system sensor (“GPS”) 212g, and vehicle sensors 212v. More or fewer sensor may be employed. For example, an alternative sensor system 210 may not employ the LIDAR 2121 and/or RADAR 212r. Additionally, or alternatively, other devices not shown in FIG. 2 may be employed.

The camera 212c, LIDAR 2121, and RADAR 212r may be configured to detect and provide sensor signals related to objects about a vehicle, such as the vehicle 140 described with respect to FIG. 1. That is, the camera 212c, LIDAR 2121, and RADAR 212r may be referred to as traffic sensors, obstruction sensors, or the like. For example, the camera may be configured to detect potential obstacles, such as pedestrians, other vehicles, bikes, etc. that are about the vehicle. The camera may also be configured to detect traffic control objects, such as a traffic light, a stop sign, lane markings, a road construction barrier, etc. The LIDAR and/or RADAR may be similarly configured to detect the objects and/or traffic control objects. Other objects, signals, or the like, that are about or related to the environment of the vehicle may also be detected.

The vehicle sensors 212v may be sensors that are configured to detect and provide sensor signals related to conditions of the vehicle, such as a throttle position sensor, an accelerometer, a braking force sensor, etc. The conditions of the vehicle can include conditions related to the position, velocity, and/or acceleration of the vehicle. The conditions of the vehicle may also include positions of control devices of the vehicle. Accordingly, the vehicle sensors 212v may provide sensor information on the condition of the vehicle so as to, for example, determine when braking force may be applied to avoid striking an object, an amount of acceleration required to reach a speed within a desirable timeframe, etc.

The sensor processor 214 may be configured to receive and process sensor signals provided by the plurality of sensors 212. For example, the sensor processor 214 may be configured to filter and buffer sensor signals from, for example, the vehicle sensors 212v. In one example, the sensor processor 214 may process a sensor signal provided by an accelerometer to remove noise, smooth data irregularities, such as drift and bias, detect and characterize transient acceleration events, perform averaging or bias analysis on a plurality of accelerations sensor signals, or the like. For example, a vehicle tends to have zero lateral acceleration while stationary, which can be used to determine relative acceleration biases between accelerometers.

The sensor processor 214 may also perform processing on images obtained by the camera 212c, LIDAR 2121, and/or RADAR 212r. For example, the sensor processor 214 may be configured to perform an object recognition algorithm on sensor signals provided by the camera 212c to detect an object, such as a traffic light. The sensor processor 214 may also correlate the sensor signals provided by camera 212c, LIDAR 2121 and/or RADAR 212r. For example, the LIDAR 2121 may be configured to detect the traffic signal and provide a sensor signal that contains information about the traffic light. The sensor processor 214 may be configured to compare, perform a redundant object recognition algorithm on, or the like, sensor signals provided by the camera 212c and the LIDAR 2121 to confirm that the detected object in the sensor signal provided by the camera 212c is a traffic light. The sensor processor 214 can also perform a spatial determination algorithm that can use, for example, the LIDAR 2121 to determine a position of the detected object relative to the LIDAR 2121.

The sensor processor 214 may also be configured to provide a control signal or signals that control the sensors 212. For example, the sensor processor 214 may provide a signal to the camera 212c to increase or decrease an ISO setting of the camera 212c to increase or reduce the camera's 212c sensitivity to light. Additionally, or alternatively, the sensor processor 214 may be configured to increase or decrease, for example, a power level of a laser in the LIDAR 2121 to improve or optimize the LIDAR's 2121 ability to sense an object. Other configurations that result in an improved or optimized ability of the camera 212c, LIDAR 2121, and RADAR 212r to detect an object may be controlled by the sensor processor 214.

The camera's 212c, LIDAR's 2121, and/or RADAR's 212r ability to sense an object may be improved or optimized by a suitable configuration of the camera 212c, LIDAR 2121, and/or RADAR 212r. The suitable configuration may, for example, reduce noise in the sensor signals, increase a dynamic range and/or optimize a contrast of the camera 212c, LIDAR 2121, and/or RADAR 212r, or the like. In an illustrative situation, during inclement weather conditions where ambient lighting may be reduced and precipitation can scatter the laser beam emitted from the LIDAR 2121, control signals provided by the sensor processor 214 may increase the ISO setting of the camera 212c and optimize the power of the laser beam emitted from the LIDAR 2121.

The sensor processor 214 may process the sensor signals provided by the sensors 212 to provide sensor information. For example, the sensor processor 214 may process the sensor signals provided by the camera 212c and the LIDAR 2121 to determine sensor information on a location of a traffic light relative to the vehicle. Additionally, or alternatively, the sensor processor 214 may be configured to provide sensor information that is based on a command signal sent by the sensor processor 214 to one of the sensors 212. The sensor processor 214 may also receive and provide sensor information reflecting a state of one or more of the sensors 212. For example, the sensor processor 214 may be configured to provide the ISO setting of the camera 212c. Accordingly, the sensor processor 214 may be configured to provide sensor information to the vehicle control system 220.

The vehicle control system 220 may be configured to receive and process the sensor information from the sensor system 210 to control the vehicle's position, velocity, and/or acceleration. The vehicle control system 220 may be an autonomous, semi-autonomous, or partially automated control system for the vehicle. By way of example, the vehicle control system 220 may be configured to perform processing necessary for one, some, or all of the Levels 1 through 5 of vehicle autonomy defined by the Society of Automotive Engineers (SAE). In Level 1, the vehicle may have minimal automation that, for example, provides assistance for steering, braking, acceleration (cruise control), or the like. At Level 5, the vehicle control system 220 may completely control the vehicle with no input from driver. The vehicle control system 220 may process the sensor information from the sensor system 210 to automate some or all of the vehicle's driving.

Accordingly, the vehicle control system 220 may be configured to process the sensor information to determine an input to the vehicle control devices 240. For example, the vehicle control system 220 may process the speed, braking, acceleration, etc. of the vehicle provided by the vehicle sensors 212v to determine, for example, that a speed (i.e., magnitude of a velocity) may need to increase or decrease. Additionally, or alternatively, the vehicle control system 220 may also determine that an angular position of a steering column should be at a position to, for example, avoid colliding with an object. Other values of variables related to the vehicle's acceleration, speed, steering, etc., may also be processed.

The vehicle control system 220 may also be configured to receive weather-related information from the vehicle processing system 230, which will be discussed in more detail in the following. The vehicle control system 220 can perform processing on the sensor information based on the weather-related information. For example, the vehicle control system 220 may determine that road conditions are likely to be slick and may adjust acceleration and/or deceleration constraints on the plurality of vehicle control devices 240.

As shown in FIG. 2, the plurality of vehicle control devices 240 is comprised of steering 240s, throttle 240t, braking 240b, wiper 240w, and light 2401 control devices, although more or fewer control devices may be employed. As can be seen, the vehicle control system 220 is communicatively coupled with each of the plurality of vehicle control devices 240. The steering 240s device may be an angular position control device that is part of a steering column in the vehicle, an actuator that is not part of a steering column, such as an actuator that is mechanically coupled to the axle and wheels of the vehicle, although any suitable control device that can control a direction of the vehicle may be employed. The throttle 240t device may be configured to control the vehicle's engine power output. The engine may be electrical or internal combustion based, a hybrid of the two, or any other suitable engine that can provide power to increase and/or decrease a speed of the vehicle. The braking 240b device may be an actuator that is mechanically coupled to the wheels of the vehicle, such as a fluid actuated brake calipers, although any suitable control device that can reduce a speed of the vehicle can be employed, such as energy recovery devices, electrically actuated calipers, or the like. The wiper 240w device may be any suitable device that controls a clearance of precipitation on the vehicle, such as the windshield of the vehicle. The light 2401 device may be any suitable device that is capable of controlling a brightness, width, and/or direction of lights, such as external lights, of the vehicle.

The vehicle processing system 230 may be configured to receive weather-related information from the antenna 230a via the vehicle processing system transceiver 230t. The antenna 230a may be configured to receive the weather-related information from, for example, the weather information station 120. The weather information station 120 may provide any suitable weather-related information, including current and predicted weather conditions. The weather information may be actual weather condition measurements, estimates of weather conditions, corrections of weather condition measurements provided by the weather station 110, etc. The weather-related information may be determined, generated, calculated, etc., by the processor 130 and provided by the processor 130 to the weather information station 120. The weather-related information may be provided by the weather information station 120 to the vehicle processing system 230 via the antenna 230a and vehicle processing system transceiver 230t.

The weather-related information provided to the vehicle processing system 230 may comprise or include a probability that a precipitation rate at or proximate the vehicle, such as the vehicle 140 described with reference to FIG. 1, may be greater than one or more values. The probability that the precipitation rate may be exceeded can be used to determine a probability that a maximum precipitation rate of a sensor is exceeded. Accordingly, the processor 130 and/or the vehicle processing system 230 may determine the probability that the maximum precipitation rate of the sensor is exceeded. The sensor may be one or more of the sensors 212 of the sensor system 210 described above, although a maximum precipitation rate of any suitable sensor may be used.

As will be described in more detail in the following, metrics may be calculated to perform scaling adjustments, such as spatial or temporal-scaling adjustments, and statistical adjustments of precipitation rates for apparatuses having precipitation sensitive sensors. For example, climatology metrics may be computed from climatology samples of the precipitation rates and these climatology metrics may be used to statistically adjust the precipitation rates for the apparatuses having precipitation sensitive sensors, such as automated vehicles, surface scanning equipment, surveying equipment, or the like.

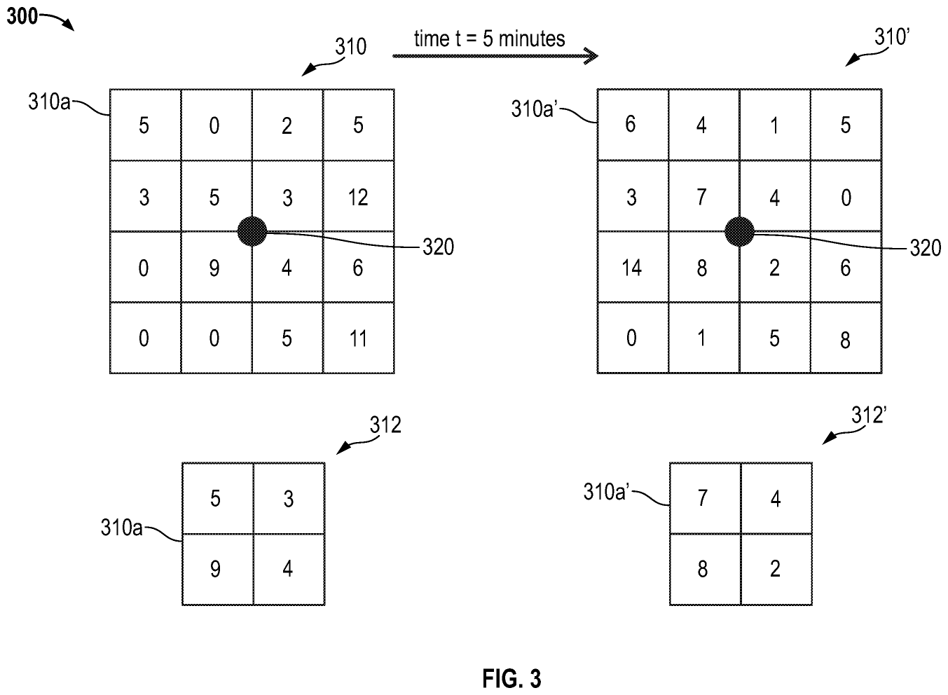

FIG. 3 shows a diagram 300 illustrating how metrics may be calculated. As shown in FIG. 3, the diagram 300 includes a region 310 that includes areas 310a that partition the region 310. Each area 310a has a corresponding average precipitation rate, which may be determined by an observation or computed to correspond to an expected observation. The average precipitation rate of each area 310a may be determined by accumulating precipitation values over a period of time, which may be referred to as a measurement integration time.

The areas 310a and the temporally subsequent areas 310a′ may have physical dimensions of about one square-kilometer, although any suitable dimensions and/or units may be employed. Accordingly, the region 310 and temporally subsequent region 310′ may have an area of 4 kilometer by 4 kilometer (km) or 16 square-kilometers (sq-km). The values of the precipitation rates of the region 310 and the temporally subsequent region 310′ are in units of millimeter per hour (mm/hr), even when measured or computed for different averaging (accumulated or integration) period than an hour, although any suitable units may be employed.

Also shown is a temporally subsequent region 310′ having temporally subsequent areas 310a′ with the same spatial dimensions as the region 310 but having average precipitation rates that are different than the region 310. A measurement integration time used to calculate the average precipitation rates of the temporally subsequent region 310′ is different than a measurement integration time used to calculate the average precipitation rates of the region 310. That is the two measurement integration times may have a same span but are at different times. The diagram 300 also includes a sub-region 312 of the region 310 that is comprised of four areas 310a that are proximate to a region of interest 320 in the region 310 and a temporally subsequent sub-region 312′ that is comprised of four temporally subsequent areas 310a′ that are proximate the region of interest 320 in the temporally subsequent region 310′.

As discussed above, the areas 310a and temporally subsequent areas 310a′ respectively partition the region 310 and temporally subsequent region 310′. As a result, the areas 310a and the temporally subsequent areas 310a′ are respectively adjacent to each other and are contiguous. Although the region 310 and temporally subsequent region 310′ are shown as having a configuration of uniform four-by-four cubic areas 310a and temporally subsequent areas 310a′, any suitable configuration may be employed, such as non-uniform areas, however other alternative areas may also be adjacent to each other and contiguous.

Accordingly, the region 310 and temporally subsequent region 310′ may respectively be approximately ergodic with respect to weather. That is, a time-series of, for example, precipitation rates in one of the areas 310a may have the same statistics as a set of surrounding areas 310a over a fixed period of time. For example, a person standing at a fixed location will measure about the same range of precipitation rates over an hour that a group of people spread out over different areas 310a in the region 310 would measure at a single instance during that hour. This may be due to weather cells moving through the region 310, creating variability in both space and time, but generally resulting in the same distribution characterization of the precipitation rate at different areas 310a in the region 310.

As can be seen, the region 310 and the temporally subsequent region 310′ are separated in time by five minutes. The average precipitation rates shown in the areas 310a and temporally subsequent areas 310a′ may be determined over a measurement integration time taken at different times that are separated by five minutes. For example, the average precipitation rates of the areas 310a may be averaged over a time-period of 1 minute as is shown, although any suitable measurement integration time may be employed.

As can be appreciated, there may be several limitations of the average precipitation rates of the areas 310a of the region 310 and the temporally subsequent areas 310a′ of the temporally subsequent region 310′. For example, there may be incomplete sampling. The observations provide a small space-time sample of the often highly variable precipitation rate. To estimate the peak rate within the observation area, it would be preferable to have hundreds or thousands of samples. That would make it possible to characterize the distribution function for the precipitation rate and accurately assess a potential peak rate that may be even greater than any of the observations. In this case, we have only 16 observations and must do our best to estimate a distribution function and what its maximum likely value is. There may also be limitations related to spatial scaling. The average precipitation rates are over 1 sq-km, but we seek the precipitation rate that might be occurring over a spatial scale as small as approximately 100 square-meter (sq-m). There may also be limitations related to temporal scaling. The average precipitation rates of the region 310 and the temporally subsequent region 310′ represent averages over 10 min, but we seek precipitation rates that may vary on approximately 10 to 60 second scales.

To address this issue, we can use a climatological sample, which has a much larger sample size, to calculate a probability associated with a precipitation rate. For example, observations may be stored in an archive as they are received by a weather information station, such as the weather information station 120 described above. The archive may accordingly include historical data, including radar data. This historical data may be the basis for a climatological sample of the region 310. From this climatological sample, various statistical metrics may be computed for a pre-defined sample basis. That sample basis may be the region 310 for which, for example, radar data are available. The computation could be done for all of the region 310 (or other regions), or for a smaller group of the region 310, such as the sub-region 312. The sub-region 312 which may, for example, correspond to a city of interest represented by the region of interest 320. The statistical metrics could include, for example, a mean, a maximum, and/or a variance for each region, such as the region 310 shown in FIG. 3, as well as relationships of those variables, such as differences or ratios, computed over some climatological time-frame, rather than over an operational time-frame. The metrics may be potentially computed separately by a season or other climatological factors.

As will be explained in more detail below, the climatology sample may not be used to calculate a localized and instantaneous precipitation rate but may rather be used to determine probabilities associated with a given precipitation rate. For example, a probability that precipitation rates will exceed a selected precipitation rate, referred to as an exceedance rate threshold, of 100 mm/hour over a 100 sq-m area during a 5-min measurement integration time may be calculated. This probability may be referred to as an exceedance rate probability. This exceedance rate probability may be used for various decisions, such as those that might be based on knowing the probability that a vehicle's sensors, such as, for example, the sensors 212 described above, will operate properly during the 5-min measurement integration time.

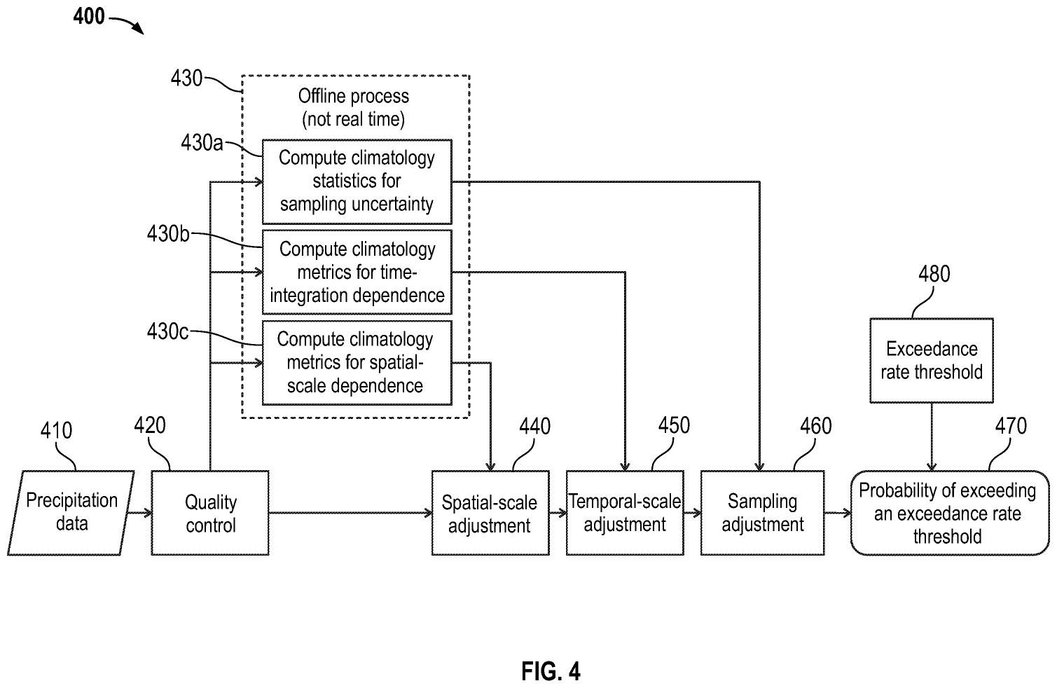

Accordingly, climatology metrics (such as mean, max, and/or variance) obtained from the climatology sample may be used in combination with observations, such as the average precipitation rates of the region 310, to estimate a probabilities of exceedance rates. That is, the climatology metrics obtained from the climatology sample may be used to calculate the probability that the precipitation rates exceed an exceedance rate threshold or the rate at which the probability is greater than an exceedance rate probability within the region 310, given the observed values for the region 310. This estimation may be done operationally in real-time. Combining the climatology metrics obtained from the climatology sample and the observations may be accomplished as discussed in the following and subsequently in more detail with reference to FIGS. 4-7.

A sampling reconstruction may be performed. For observed average precipitation rates of areas within a region, such as the areas 310a of the region 310 described above, a maximum average precipitation rate within that region is by definition equal to or larger than a mean of the average precipitation rates. A mean of the average precipitation rates may be computed. The average precipitation rates of the areas 310a of the region 310 may also provide 16 samples to determine a variability of the average precipitation rates associated with the mean precipitation rate of the region 310. Computing a relationship, such as the difference and/or the ratio between the maximum and the mean of the average precipitation rates, may provide an estimate of what an actual maximum would be if metrics from climatology, which may have statistically significant sample size, are used. That is, the relationship between the mean and the maximum of the average precipitation rates may have a statistical distribution amenable to characterization using the climatological data. Once the climatological distribution is characterized, that information can be used to estimate the probability of an actual maximum rate given the average precipitation rates of a region. This means we can estimate probabilities for an actual maximum that we would observe if we could measure at many more locations within that area.

The observed variance in the region can be used to further refine this estimate, such as based on whether the variance is large or small compared to the variance determined using the climatology. For example, separate climatology metrics might be computed for cases where a variance of the average precipitation rates of the region is low and high. Application of this methodology allows operational predictions such as: if the observed mean of the average precipitation rate of the region is 2 mm/hour and the variance is high, a maximum additional rate of greater than 5 mm/hour (total of 7 mm/hr) somewhere within the region might be expected less than 50% of the time and a maximum additional rate of greater than 10 mm/hour might be expected less than 5% of the time.

A spatial scale adjustment may also be performed. A spatial downscaling relationship, computed from the climatology, can be used to relate the estimated maximum rate of the region to a rate of a smaller area. This climatological relationship can be computed by comparing average rates over sub-regions or regions of different sizes (e.g., 1 sq-km, 4 sq-km, 16 sq-km), as illustrated by the region 310 and the sub-region 312 and extrapolating to smaller scales. The “extrapolation factor” (typically a small percentage increase) may then be applied to the estimated maximum precipitation rate determined in the sampling reconstruction step.

A temporal-scaling adjustment may also be performed. A temporal downscaling relationship, computed from the climatology, is used to relate the estimated maximum rate of any temporal integration to shorter measurement integration times. The temporal downscaling climatological relationship can be computed by comparing the mean of the average precipitation rates over various measurement integration times and extrapolating to smaller scales. The “extrapolation factor” (typically a small percentage increase) is then applied to the estimated maximum precipitation rate determined in the prior steps. In the particular case of radar observations, this step may not be needed since the sampling already occurs with second-scales.

Using this methodology or system, estimates of current localized, instantaneous precipitation rate could be obtained from the current observations. For forecasts to determine estimates of localized, instantaneous precipitation rates for future times, those observations are replaced by their forecast estimates and the same methodology is followed. To enhance fidelity of the information, the precipitation rate estimates obtained using this method can be calibrated against climatology expectations, such as those developed under International Telecommunications Union (ITU) standard or similar methodologies. An exemplary methodology is described in the following.

FIG. 4 shows a flow chart 400 for determining a probability that a maximum precipitation rate of a sensor is exceeded. As shown in FIG. 4, the flow chart 400 begins by obtaining precipitation data 410. The precipitation data 410 may be obtained by, for example, the weather station 110, although any suitable station may be employed. The flow chart 400, performs quality control 420 on the precipitation data, which may include discarding known bad data in the precipitation data, correcting for biases in the precipitation data, etc. The flow chart 400 shows that after the quality control 420 is performed on the precipitation data, offline processes 430 may be performed on the precipitation data. As shown in FIG. 4, the offline processes 430 includes computing climatology statistics for sampling uncertainty 430a, computing climatology metrics for time-integration dependence 430b, and computing climatology metrics for spatial-scale dependence 430c. The offline processes can be performed over climatological time-frames and can therefore result in statistically significant metrics due to relatively large sample sizes. The precipitation data may also be provided to a spatial scale adjustment 440, a temporal-scale adjustment 450, and a sampling adjustment 460 to provide a probability of exceeding 470 an exceedance rate threshold 480.

The precipitation data 410 may be obtained by one or more weather stations, such as the weather station 110 described above with reference to FIG. 1. The precipitation data may include data that is inaccurate. For example, an actual precipitation rate may be 80 mm/hr but is incorrectly measured as 50 mm/hr. Accordingly, the quality control 420 may detect and remove the inaccurate precipitation data. The quality control 420 can use any suitable method to detect and remove inaccurate data, such as, comparing data with a moving average and deleting data that lies outside a threshold from the moving data, etc.

As discussed above, the precipitation data 410 may include precipitation rates that are calculated over various spatial and time-scales. For example, a RADAR measurement of a precipitation rate of 10 mm/hr may be integrated over, for example, five seconds. That is, during a five second measurement integration time, the measured precipitation rate was 10 mm/hr. Similarly, the RADAR may have a spatial resolution associated with the precipitation rate of, for example, 1 sq-km, which may be much smaller than a spatial-scale of an area in a region. As can be appreciated, the precipitation data 410 may need to be temporally and spatially scaled to be relevant to a maximum precipitation rate of a sensor.

To address this issue, the precipitation data 410 provided by the quality control 420 is shown as being provided to the offline processes 430 and to the spatial-scale adjustment 440, temporal-scale adjustment 450, and the sampling adjustment 460. The offline processes 430 may compute metrics like an average, maximum, and variance of the precipitation data on a climatological scale such as over a period of years and on a climatological basis such as seasons or by month. For example, the offline processes may compute precipitation rate averages, maximums, and variances for areas of a region, such as the region 310 discussed above, for the month of August (the climatological basis) using data that spans several years. Due to the sample size of the precipitation data being relied on, the metrics calculated by the offline processes 430 may be statistically significant.

The metrics calculated by the offline processes 430 may then be provided to spatial scale adjustment 440, temporal-scale adjustment 450, and the sampling adjustment 460 to ensure that an output is both statistically significant and is “operational” or relevant to current conditions about a vehicle.

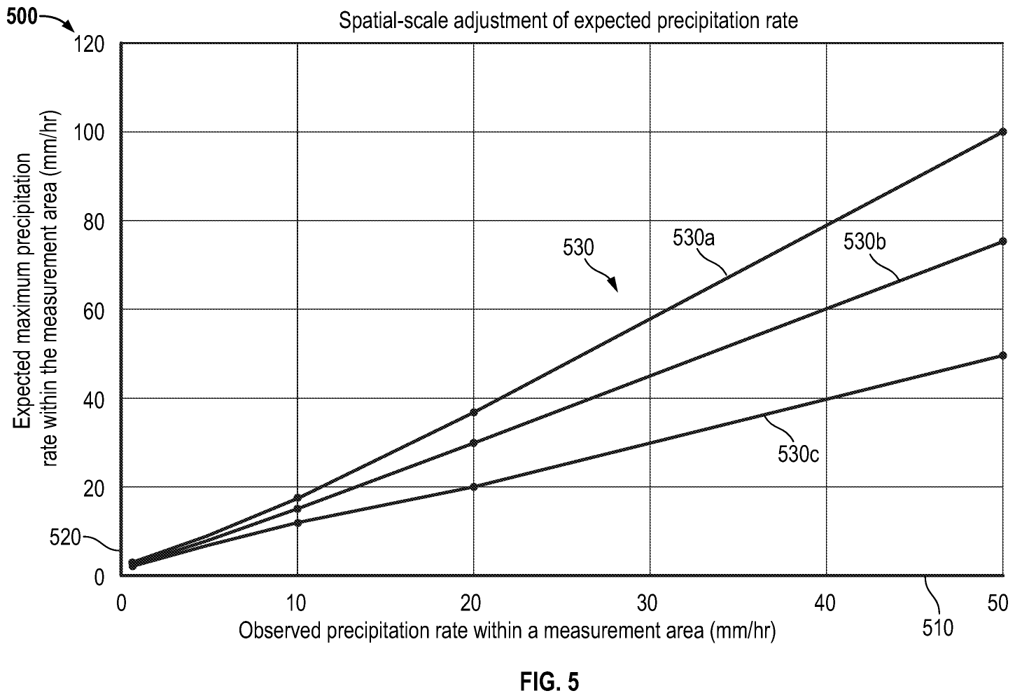

As shown in FIG. 4, the spatial-scale adjustment 440 can receive the computed climatological metrics for spatial-scale dependence 430c and adjust, for example, a spatial-scale of a region of interest, such as the region of interest 320 described with reference to FIG. 3. The spatial-scale of the region of interest may be about 125 sq-m. The spatial-scale of the region of interest may be an area in which objects are detectable by, for example, the LIDAR 2121 described with reference to FIG. 2. As discussed above, the LIDAR 2121 may have a maximum precipitation rate for the region of interest. That is, if an actual precipitation rate for the region of interest is greater than the LIDAR's 2121 maximum precipitation rate, then the performance of the LIDAR 2121 may degrade. The spatial-scale adjustment 440 of the region of interest will be described in more detail in the following with reference to FIG. 5.

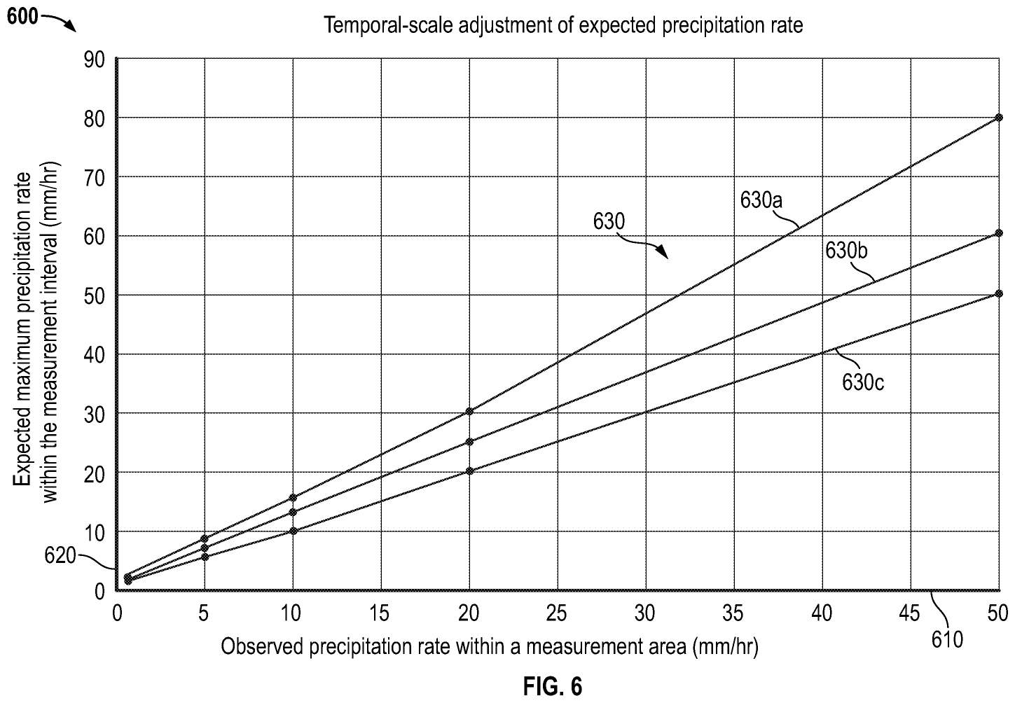

The temporal-scale adjustment 450 can receive the computed climatological metrics for time-integration dependence 430b and adjust, for example, a temporal-scale of the region of interest, such as the region of interest 320 described with reference to FIG. 3. The temporal-scale of the region of interest may be 10 seconds, although any suitable temporal-scale may be employed. The temporal-scale of the region of interest may be a measurement integration time that the maximum precipitation rate of the LIDAR 2121 is specified at. For example, the LIDAR 2121 may have a maximum precipitation rate of 10 mm/hr that is specified for an integration interval of ten seconds. In other words, the performance of the LIDAR 2121 may be sufficient if the actual precipitation rate determined by integrating over a ten second interval is less than the maximum precipitation rate of the LIDAR 2121. The temporal-scale adjustment 450 is described in more detail in the following with reference to FIG. 6.

Still referring to FIG. 4, the sampling adjustment 460 may use a result of the offline process 430 of computing climatology statistics for sampling uncertainty 430a. More specifically, the sampling adjustment 460 can use the estimated maximum precipitation rate value of a measurement area and interval to determine a probability that precipitation rates may exceed an exceedance rate threshold value.

FIG. 5 shows a chart 500 illustrating a spatial-scale adjustment of an observed precipitation rate value. As shown in FIG. 5, the chart 500 includes an observed precipitation rate axis 510 and an expected precipitation rate axis 520, which are in units of mm/hr, although any suitable units may be employed. The chart 500 also includes measurement area relationships 530. The measurement area relationships 530 relates observed precipitation rate values calculated for an observed precipitation rate measurement area with expected maximum precipitation rates calculated for a maximum precipitation rate measurement area. The measurement area relationships 530 is comprised of a 16 sq-km measurement area plot 530a, a 1 sq-km measurement area plot 530b, and a 125 sq-m measurement area plot 530c.

The 16 sq-km measurement area plot 530a and the 1 sq-km measurement area plot 530b are scaled relative to the 125 sq-m measurement area plot 530c. That is, the 125 sq-m measurement area plot 530c is a reference relationship between observed precipitation rate values and expected maximum precipitation rate values. The 125 sq-m measurement area plot 530c assumes that the observed precipitation rate values are instantaneous precipitation rate values. Accordingly, there is a one-to-one relationship between observed precipitation rate values and expected precipitation rate values. Therefore, the 125 sq-m measurement area plot 530c may be viewed as a highest spatial-resolution measurement area and therefore, there could be no maximum precipitation rate within the 125 sq-m measurement area.

As mentioned above, the 16 sq-km measurement area plot 530a is scaled relative to the 125 sq-m measurement area plot 530c. Accordingly, in contrast to the 125 sq-m measurement area plot 530c, the 16 sq-km measurement area plot 530a shows that a maximum precipitation rate likely occurred when averaged over a 16 sq-km measurement area. According to the 16 sq-km measurement area plot 530a, an expected maximum precipitation rate value is greater than an observed precipitation rate value determined for the 16 sq-km measurement area. For example, if an observed precipitation rate averaged over a 16 sq-km measurement area is 20 mm/hour, the 16 sq-km measurement area plot 530a shows that a 125 sq-m measurement area within the 16 sq-km measurement has a maximum precipitation rate of 36 mm/hr. Temporal-scaling can also be performed, as the following explains.

FIG. 6 shows a chart 600 illustrating a temporal-scale adjustment from a relatively long measurement integration time to a sensor measurement integration time of 10 seconds. As shown in FIG. 6, the chart 600 includes an observed precipitation rate axis 610 and an expected precipitation rate axis 620, which are in units of mm/hr, although any suitable units may be employed. The chart 600 also includes measurement integration time relationships 630. The measurement integration time relationships 630 relates observed precipitation rate values calculated at an observed precipitation rate measurement integration time with expected precipitation rates calculated at an expected precipitation rate interval. The measurement integration time relationships 630 is comprised of a one-hour measurement integration time plot 630a, a ten-minute measurement integration time plot 630b, and a ten second measurement integration time plot 630c.

The one-hour measurement integration time plot 630a and the ten-minute measurement integration time plot 630b are scaled relative to the ten-second measurement integration time plot 630c. That is, the ten-second measurement integration time plot 630c is a reference relationship between observed precipitation rate values and expected precipitation rate values. The ten-second measurement integration time plot 630c assumes that the observed precipitation rate values are instantaneous precipitation rate values. Accordingly, there is a one-to-one relationship between observed precipitation rate values and expected precipitation rate values. Therefore, the ten-second measurement integration time plot 630c may be viewed as a highest temporal-resolution measurement integration time and therefore, there could be no maximum precipitation rate within a ten-second measurement integration time.

As mentioned above, the ten-minute measurement integration time plot 630b is scaled relative to the ten-second measurement integration time plot 630c. Accordingly, in contrast to the ten-second measurement integration time plot 630c, the ten-minute measurement integration time plot 630b shows that a maximum instantaneous precipitation rate likely occurred during a ten-minute measurement integration time. According to the ten-minute measurement integration time plot 630b, an expected maximum instantaneous precipitation rate value is greater than an observed precipitation rate value determined using the ten-minute measurement integration time.

For example, suppose a rain gauge is measuring a precipitation rate by averaging (accumulating) over a ten-minute period, and the rain gauge reports a precipitation rate of 30 mm/hr. An actual instantaneous precipitation rate can vary during the ten-minute measurement integration time and therefore a maximum instantaneous precipitation rate can occur during the ten-minute measurement integration time. The measurement integration time relationships 630 can be used to scale an observed precipitation rate value that is based on a ten-minute measurement integration time to an expected maximum instantaneous precipitation rate value during the ten-minute measurement integration time. More specifically, the ten-minute measurement integration time plot 630b can be used to determine that a maximum precipitation rate that is based on a ten-second measurement integration time of about 36 mm/hr likely occurred within that 10-minute measurement integration time of the observed integrated precipitation rate value of 30 mm/hr.

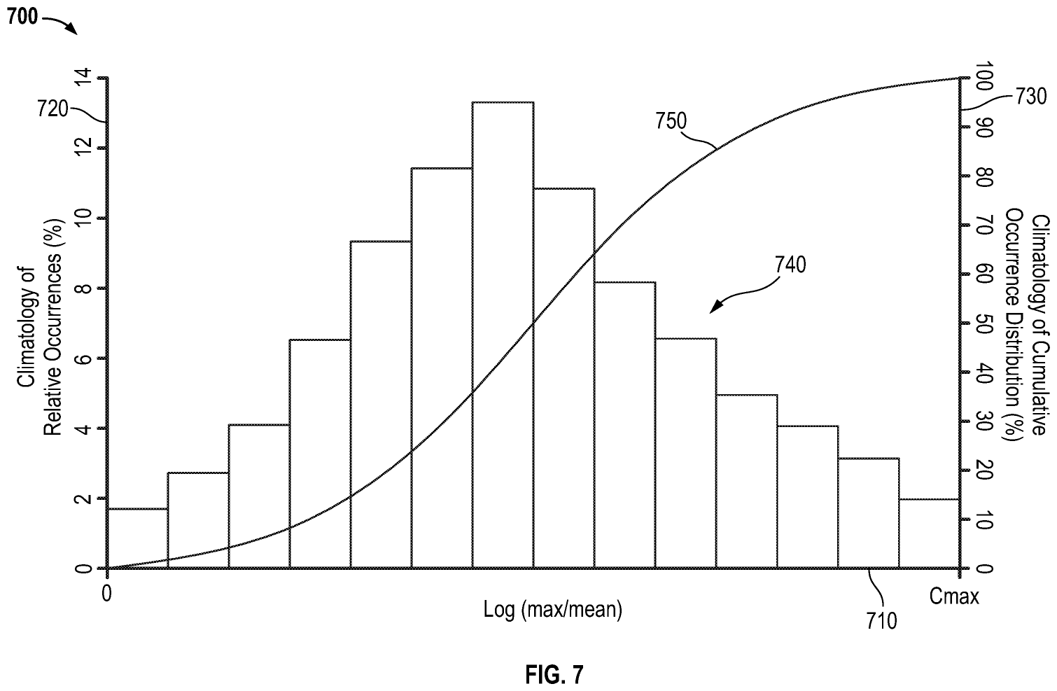

FIG. 7 shows a chart 700 illustrating probability distributions of a climatological metrics relationship between a maximum precipitation rate and a mean precipitation rate. As shown in FIG. 7, the chart 700 shows a bin axis 710 that includes bins that range from 0 to a climatological maximum Cmax, although any suitable range may be employed. The chart 700 also includes a climatology of relative occurrences axis 720, which is in percentages of total number of occurrences. Also shown is a cumulative percentage axis 730 that ranges from 0 to 100 percent, which represents an accumulation of the probability distribution 740 from 0 to 100 percent. The chart 700 also includes a probability distribution 740 comprising a plurality of bins and a cumulative probability distribution 750.

The probability distribution 740 may be representative of an area or region, such as the region of interest 320 described above. That is, the probability distribution 740 may be climatological precipitation rates of the areas 310a of the region 310 that are temporally and/or spatially scaled to the region of interest 320 as described above with reference to FIGS. 4-6. Alternatively, the probability distribution 740 may be representative of the region 310 described above, where the temporal and/or spatial scales of the exceedance rate threshold are scaled to the temporal and/or spatial scales of the areas 310a of the region 310. That is, in this latter example, an order of the spatial-scale adjustment 440, temporal-scale adjustment 450, and the sampling adjustment 460 may be reversed where the probability distribution 740 is used for sampling adjustment 460 before the temporal 450 and/or spatial scaling adjustments 440.

A width of a given bin in the probability distribution 740 is a range of logarithm of a maximum and mean of average precipitation rates of a region. For example, where the maximum and the mean of the average precipitation rates of the region are equal to each other, then the ratio is 1, which has a logarithm value of zero of the first bin of the probability distribution 740. The bin axis 710 is unit-less. The chart 700 accordingly includes the count axis 720, which counts the number of occurrences the log (max/mean) value occurs within the width of a given bin. The count axis 720 is unit-less. Also shown is a cumulative probability distribution 750 of the probability distribution 740.

FIG. 7 characterizes the climatological metrics of the climatological sample, such as the precipitation data 410 discussed above, using the climatological metrics relationship of log (max/mean), as determined from, for example, a year of data at a measurement area. Operationally, the mean of the log (max/mean) may be the mean value of the sixteen measurement areas in a region, such as the region 310 discussed above. The max of log (max/mean) may be a maximum precipitation rate for a measurement area.

A probability that a precipitation rate may be greater than an exceedance rate threshold can be calculated by determining a logarithm of a ratio between the exceedance rate threshold and a mean of an area or region. For example, the exceedance rate threshold may be a maximum precipitation rate of a sensor. The maximum precipitation rate may be divided by a mean of precipitation rates of a region. For example, a logarithm may be calculated by a ratio of the maximum precipitation rate of the sensor and a mean of precipitation rates for an area or region, such as the region of interest 320 discussed above. The result of this calculation can be compared to the cumulative probability distribution 750 to determine a probability that the precipitation rate may exceed the maximum precipitation rate of the sensor in the area or region.

In an exemplary calculation using FIGS. 5-7, precipitation rates may be measured for a region, such as the areas 310a of the region 310 described above. As shown in FIG. 3, the region 310 may have an area of 16 sq-km. The precipitation rates may be measured over an integration or accumulation measurement period of 10 minutes, for example. A mean value of the areas 310a may be calculated as is described above.

An exceedance rate threshold may also be determined, which may be a maximum precipitation rate of a sensor, such as the LIDAR 2121 described above. A vehicle, such as the vehicle 140 described above, may determine and provide the exceedance rate threshold. The maximum precipitation rate of the LIDAR 2121 may be a rate at which the LIDAR 2121 fails to operate correctly. The maximum precipitation rate of the sensor may be considered an instantaneous rate, such as 60 mm/hr, for a relatively small area. The area may be, for example, 100 sq-m.

The exceedance rate threshold may be temporal scale adjusted to reflect an expected maximum precipitation rate taken over a ten-minute interval. For example, the chart 600 may be used to adjust the 60 mm/hr of a ten-second measurement integration time to 50 mm/hr of a ten-minute measurement integration time. The exceedance rate threshold may also be spatially-scale adjusted to reflect an expected maximum precipitation rate of a 16 sq-km measurement area. For example, the chart 500 may be used to spatially adjust the temporally adjusted expected precipitation rate of 50 mm/hr of a 125 sq-m area to an expected maximum precipitation rate of 27 mm/hr of the 16 sq-km region.

The chart 700 may be used to perform a sampling adjustment on the temporally and spatially adjusted exceedance rate threshold value of 27 mm/hr to determine a probability that an actual precipitation rate in the region of interest 320 may exceed the exceedance rate threshold of 60 mm/hr. For example, a logarithm of the temporally and spatially scaled exceedance rate threshold value of 27 mm/hr divided by the mean of the averaged precipitation rates of the areas 310a of the region 310 may be calculated and compared to the chart 700; in particular, the bin axis 710. The probability of that precipitation rate of the region of interest 320 may be calculated from the cumulative probability distribution 750.

As suggested above with reference to FIGS. 5-7, the spatial and temporal scaling may be performed before the sampling adjustment is performed. For example, in contrast to FIG. 4, the sampling adjustment may be performed before the spatial and temporal adjustment by, for example, providing the chart 700 using climatological precipitation rates that are adjusted to a spatial and temporal scale of an exceedance rate threshold. As can also be appreciated, a probability, rather than an exceedance rate threshold, may be provided. For example, the vehicle may provide one or more probabilities, such as a list of probabilities. The one or more probabilities may correspond to desired operational up-times of different sensors of the vehicle. The one or more probabilities may be provided and used to calculate corresponding exceedance rate thresholds, which may be calculated before temporal and/or spatial scaling.

These and other calculations may be performed by any suitable method performed by a station, processor, or the like, such as the weather information station 120 and/or processor 130 described above. An exemplary method 800 is described in the following.

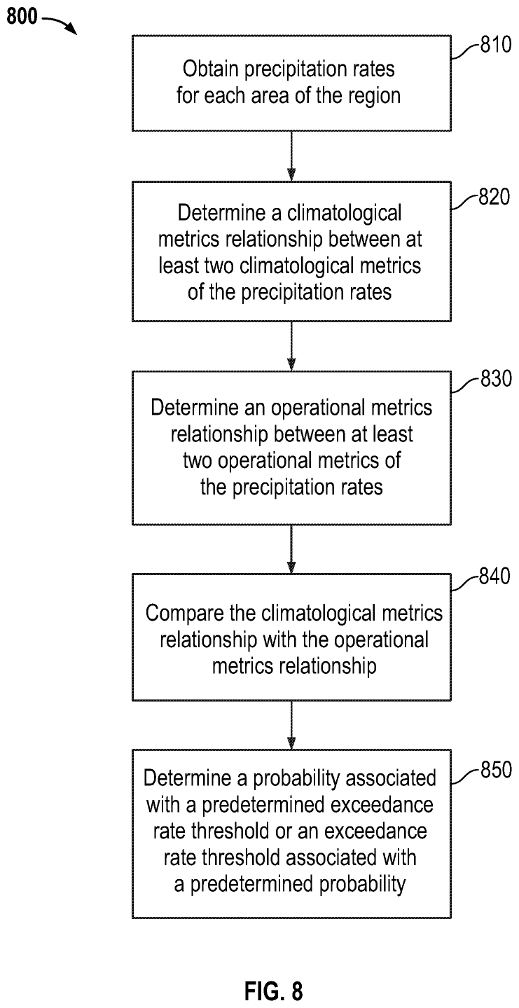

FIG. 8 shows a method 800 for scaling and statistical adjustments of precipitation rates for automated driving. The method 800 may be performed by the weather information station 120 and/or the processor 130 discussed above, although any suitable weather information station and/or processor may be employed. Accordingly, the processor 130 may be configured to perform the following steps. As shown in FIG. 8, the method 800 obtains precipitation rates for each area of a region in step 810. In step 820, the method 800 determines a climatological metrics relationship between at least two climatological metrics of the precipitation rates. In step 830, the method 800 determines an operational metrics relationship between at least two operational metrics of the precipitation rates. The method 800, in step 840, compares the climatological metrics relationship with the operational metrics relationship. The comparison, in step 850, may determine a probability associated with a predetermined exceedance rate threshold and/or an exceedance rate threshold associated with a predetermined probability.

The climatological metrics may be a maximum and a mean of a climatological sample of the precipitation rates of the areas of the region. The operational metrics may be a maximum and a mean of an operational sample of the precipitation rates of the areas of the region. The climatological sample may be made over multiple years and/or seasons and therefore may have a statistically large sample size. That is, the climatological sample may result in statistically significant climatological statistical metrics. The operational sample may be of precipitation rates that temporally and/or spatially proximate a vehicle, city, or the like. For example, the operational sample may be comprised of instantaneous precipitation rates of the region that the vehicle may be experiencing and/or may be expected to experience. For example, a vehicle may be traversing a region that is presently experiencing a weather system that has a precipitation rate of 60 to 100 mm/hr. Accordingly, the operational sample may include precipitation rates of the weather system, but may not include precipitation rates of past weather systems.

The climatological metrics relationship may comprise a relationship between the maximum and the mean of the climatological sample of the precipitation rates of the areas of the region. The operational metrics relationship may comprise a relationship between the maximum and the mean of the operational sample of the precipitation rates of the areas of the region. The climatological metrics relationship and the operational metrics relationship may be ratios, differences, or the like, and/or values that are derived from the ratios, differences, or the like. For example, with reference to FIG. 7, the climatological metrics relationship and the operational metrics relationship may be a logarithm of a maximum and a mean of precipitation rates of an area of a region.

The probability associated with a predetermined exceedance rate may be a probability that a maximum precipitation rate of one or more areas of the region is greater than the exceedance rate threshold. For example, the method 800 may determine using, for example, the flow chart 400, which may be performed by the weather information station 120 and/or processor 130, a probability that the precipitation rate may exceed 100 mm/hr. In one example, the method 800 may use a logarithm of a ratio of a maximum precipitation rate and a mean precipitation rate of an area to determine the probability by referring to the cumulative probability distribution 750 shown in FIG. 7.

The method 800 may further comprise performing a spatial-scale adjustment of the precipitation rates of the areas of the region to a spatial-scale of an operational region. For example, as discussed above with reference to FIG. 5, the precipitation rates taken over a large area, such as 16 sq-km, may be scaled to 100 sq-m. The 100 sq-m may be an operational scale and therefore may be useful for automated driving. That is, a sensor in, for example, the vehicle 140 described above, may have a maximum precipitation rate that is considered an instantaneous precipitation rate and therefore any precipitation rates within the 100 sq-m greater than the maximum precipitation rate of the sensor would result in degraded performance of the sensor.

The method 800 may further comprise performing a temporal-scale adjustment of the precipitation rates of the areas of the region to a temporal-scale of an operational period. For example, as discussed above with reference to FIG. 6, the precipitation rates taken with a ten-minute measurement integration time may be scaled to a ten-second measurement integration time. The ten-second measurement integration time may be an operational scale and therefore may be more useful for automated driving. That is, a sensor in, for example, the vehicle 140 described above, may have a maximum precipitation rate that is considered an instantaneous precipitation rate and therefore any precipitation rates during the ten-minute measurement integration time greater than the maximum precipitation rate of the sensor would result in degraded performance of the sensor.

The exceedance rate threshold may be based on a maximum precipitation rate of a sensor. For example, the exceedance rate threshold may be the maximum precipitation rate of the sensor. As discussed above, the maximum precipitation rate of the sensor may be a precipitation rate at which a performance of the sensor degrades. The sensor may be the sensors 212 discussed above, although any suitable sensor may be employed.

The system 100 and method 800 for scaling and statistical adjustments of precipitation rates for automated driving can provide an probability that a precipitation rate of a region of interest, such as an region around a vehicle, will exceed a maximum precipitation rate of a sensor. For example, the vehicle can provide a maximum precipitation rate of a sensor and receive the probability that the precipitation rate will exceed the exceedance rate threshold. The probability may be provided to the vehicle by a weather information system that receives the maximum precipitation rate. Additionally, or alternatively, the system 100 and method 800 can provide an exceedance rate threshold when provided with a probability. For example, the vehicle may provide the probability due to an algorithm that adjusts based on a probability that the precipitation rate will exceed a sensor's maximum precipitation rate by a certain amount.

Accordingly, the vehicle may make adjustments, such as adjusting inputs to an algorithm to rely more, or only on, data provided by sensors that have higher maximum precipitation rates, slowing the vehicle down, reverting control of the vehicle to the vehicle's operator, and/or the like. Such adjustments may be made even though a temporal-scale and/or spatial-scale of the precipitation rate measurements may not be similar to a temporal-scale and/or spatial-scale of the sensor. Therefore, traditional precipitation rate measurements may be utilized for automated driving, without significant investment in a precipitation rate measurement infrastructure.

The detailed descriptions of the above embodiments are not exhaustive descriptions of all embodiments contemplated by the inventors to be within the scope of the present description. Indeed, persons skilled in the art will recognize that certain elements of the above-described embodiments may variously be combined or eliminated to create further embodiments, and such further embodiments fall within the scope and teachings of the present description. It will also be apparent to those of ordinary skill in the art that the above-described embodiments may be combined, in whole or in part, to create additional embodiments within the scope and teachings of the present description.

Thus, although specific embodiments are described herein for illustrative purposes, various equivalent modifications are possible within the scope of the present description, as those skilled in the relevant art will recognize. The teachings provided herein can be applied to other systems and methods for using weather data to improve weather information and not just to the embodiments described above and shown in the accompanying figures. Accordingly, the scope of the embodiments described above should be determined from the following claims.

1. A system for scaling and statistical adjustments of precipitation rates for apparatuses having precipitation sensitive sensors, the system comprising:
a weather information station configured to provide precipitation rates for areas of a region; and
a processor in communication with the weather information station, the processor being configured to:
obtain the precipitation rates of the areas of the region;
determine a climatological metrics relationship between at least two climatological metrics of the precipitation rates;
determine an operational metrics relationship between at least two operational metrics of the precipitation rate;
compare the climatological metrics relationship with the operational metrics relationship; and
determine at least one of:
a probability associated with a predetermined exceedance rate threshold; and
an exceedance rate threshold associated with a predetermined probability.

2. The system of claim 1, wherein:
the at least two climatological metrics comprises a maximum and a mean of a climatological sample of the precipitation rates of the areas of the region; and
the at least two operational metrics comprises a maximum and a mean of an operational sample of the precipitation rates of the areas of the region.

3. The system of claim 2, wherein:
the climatological metrics relationship comprises a relationship between the maximum and the mean of the climatological sample of the precipitation rates of the areas of the region; and
the operational metrics relationship comprises a relationship between the maximum and the mean of the operational sample of the precipitation rates of the areas of the region.

4. The system of claim 1, wherein the probability associated with the predetermined exceedance rate threshold and the predetermined probability are a probability that a maximum precipitation rate of one or more areas of the region is greater than the predetermined exceedance rate threshold.

5. The system of claim 1, wherein the processor is further configured to perform a spatial-scale adjustment of the precipitation rates of the areas of the region to a spatial-scale of an operational region.

6. The system of claim 1, wherein the processor is further configured to perform a temporal-scale adjustment of the precipitation rates of the areas of the region to a temporal-scale of an operational period.

7. The system of claim 1, wherein the exceedance rate threshold is based on a maximum precipitation rate of a sensor in a vehicle.

8. A method for scaling and statistical adjustments of precipitation rates for apparatuses having precipitation sensitive sensors, the method comprising:
obtaining precipitation rates for areas of a region;
determining a climatological metrics relationship between at least two climatological metrics of the precipitation rates;
determining an operational metrics relationship between at least two operational metrics of the precipitation rates;
comparing the climatological metrics relationship with the operational metrics relationship; and
determining at least one of:
a probability associated with a predetermined exceedance rate threshold; and
an exceedance rate threshold associated with a predetermined probability.

9. The method of claim 8, wherein:
the at least two climatological metrics comprise a maximum and a mean of a climatological sample of the precipitation rates of the areas of the region; and
the at least two operational metrics comprise a maximum and a mean of an operational sample of the precipitation rates of the areas of the region.

10. The method of claim 9, wherein the climatological metrics relationship comprises a relationship between the maximum and the mean of the climatological sample of the precipitation rates of the areas of the region and the operational metrics relationship comprises a relationship between the maximum and the mean of the operational sample of the precipitation rates of the areas of the region.

11. The method of claim 8, wherein the probability associated with a predetermined exceedance rate and the predetermined probability is a probability that a maximum precipitation rate of one or more areas of the region is greater than the predetermined exceedance rate threshold.

12. The method of claim 8, further comprising performing a spatial-scale adjustment of the precipitation rates of the areas of the region to a spatial-scale of an operational region.

13. The method of claim 8, further comprising performing a temporal-scale adjustment of the precipitation rates of the areas of the region to a temporal-scale of an operational period.

14. The method of claim 8, wherein the exceedance rate threshold is based on a maximum precipitation rate of a sensor in a vehicle.
